(19) United States
(12) Patent Application Publication
(10) Pub. No.: US 2014/0379512 A1
(43) Pub. Date: Dec. 25, 2014

(54) SYSTEM, DEVICE AND METHOD FOR FORMULA MANAGEMENT

(71) Applicant: BigMachines, Inc., Deerfield, IL (US)

(72) Inventors: ZAKIYA S. VALLIER, CHICAGO, IL (US); RICHARD L. JONES, GRAYSLAKE, IL (US); FAZAL GUPTA, ARLINGTON HEIGHTS, IL (US)

(21) Appl. No.: 13/923,320

(22) Filed: Jun. 20, 2013

(51) Int. Cl. G06Q 30/06

(52) U.S. Cl. CPC G06Q 30/0611
USPC 705/26.4

(57) ABSTRACT

A system, device and method involve the management of formulas. In one embodiment, the formulas are buildable through the selection of mathematical components. A formula list facilitates formula management.

### CROSS REFERENCE TO RELATED APPLICATIONS

This application is related to the following commonly-owned, co-pending patent applications: U.S. patent application Ser. No. 12/247,039, filed on Oct. 7, 2008; U.S. patent application Ser. No. 12/443,549, filed on Apr. 30, 2009; U.S. patent application Ser. No. 13/279,025, filed on Oct. 21, 2011; and U.S. patent application Ser. No. 13/279,015, filed on Oct. 21, 2011.

### COPYRIGHT NOTICE

A portion of the disclosure of this patent document contains, or may contain, material which is subject to copyright protection. The copyright owner has no objection to the photocopy reproduction by anyone of the entire patent document in exactly the form it appears in the Patent and Trademark Office patent file or records, but otherwise reserves all copyrights whatsoever.

### BACKGROUND

When companies provide quotes for their products, they often use formulas. A common formula, for example, is the total per item price equal to the per-unit price multiplied by the quantity of units requested. Companies use their formulas to account for various factors, such as discounts and promotions. Some companies have relatively large product portfolios, and they offer various discount policies for various customers or order volumes. It can be burdensome for companies to manage these formulas. Companies can incur significant labor costs associated with managing the formulas. Companies can also suffer from slowed work flow, delays in the sales cycle process and risks of erroneous formula entry.

Therefore, there is a need to overcome, or otherwise lessen the effects of, the challenges, drawbacks and disadvantages described above.

### SUMMARY

In one embodiment, the system facilitates the quoting process. The system includes an offering data module, a quoting module and a formula management module. Administrators, such as pricing managers, can use the formula management module to build and maintain a list of quote-related formulas. When a sales representative or sales agent uses the quoting module for a potential sale, the system applies the formulas to generate quotes seamlessly without the sales agents needing to perform the calculations themselves.

In one embodiment, the system includes a data storage device configured to store data. The data is associated with the following: (a) a plurality of different mathematical components; (b) a component identifier associated with each one of the mathematical components; (c) a plurality of different mathematical operators; (d) an operator identifier associated with each one of the mathematical operators; (e) a plurality of different formula identifiers; and (f) the cost of a plurality of different offerings. The data storage device is accessible, over a network, by a processor.

The system includes a formula management instruction set stored within the data storage device. The formula management instruction set includes a plurality of instructions which are executable by the processor to: (a) cause one of the formula identifiers to be displayed, wherein the formula identifier is associated with a formula; (b) cause a plurality of the component identifiers to be displayed; (c) receive a sequence of selections for the user's building of the formula, wherein the selections include a plurality of the component identifiers and at least one of the operator identifiers; (d) cause the formula to be displayed according to the sequence, wherein the formula displays the selected component identifiers and the operator identifier; (e) repeat steps (a) through (d) for the user's building of another formula; and (f) display a formula list. Each item in the formula list includes one of the formula identifiers and one of the formulas.

The system also includes a quote building instruction set stored within the data storage device. The quote building instruction set includes a plurality of instructions which are executable by the processor to: (a) cause a quote building template to be displayed, wherein the quote building template has a plurality of different quote data fields, and the quote data fields are associated with different ones of the formulas; (b) mathematically apply the formulas to generate a plurality of data results related to at least one of the offerings; (c) fill the quote data fields with the data results; and (d) generate a quote output or quote based on the template.

In one embodiment, the offerings include products and services. In one embodiment, a plurality of the instructions are executable by the processor to: (a) edit one of the formulas in response to an edit input received; (b) mathematically apply the edited formula to generate a data result; and (c) fill one of the quote data fields with the data result. In one embodiment, the mathematical components include one or more of the following: a variable, a constant, a value, a function, an argument or a condition.

In one embodiment, each one of the component identifiers includes at least one letter of a word. The letter is at least partially descriptive of the mathematical component associated with the component identifier.

In one embodiment, a plurality of the instructions are executable by the processor to: (a) receive a build formula input from the user; (b) cause a component data field to be displayed in response to the build formula input; (c) receive at least one letter entered into the component data field by the user; (d) in response to the entered letter, cause at least part of a component identifier list to be displayed in alphabetical order, wherein the displayed part includes a plurality of the component identifiers which begin with the letter; and (e) receive a selection signal based on the user's pointing to one of the component identifiers in the component identifier list.

Additional features and advantages of the present invention are described in, and will be apparent from, the following Brief Description of the Figures and Detailed Description.

### BRIEF DESCRIPTION OF THE FIGURES

FIG. 1 is a schematic block diagram illustrating one embodiment of the system.

FIG. 2 is a view of one example of one embodiment of an offering search interface of the system.

FIG. 3 is a view of one example of one embodiment of a quote building template interface of the system.

FIG. 4 is an enlarged view of the general information section and quote detail section of the example of FIG. 3.

FIG. 5 is an enlarged view of the quote preview of the example of FIG. 3.

FIG. 6 is an enlarged view of one example of one embodiment of the quote detail section of the example of FIG. 3.

FIG. 7 is an enlarged view of one example of one embodiment of the quote preview section of the example of FIG. 3.

FIG. 8 is schematic block diagram illustrating examples of different embodiments of the mathematical components and formulas of the system.

FIG. 9 is a view of one example of one embodiment of a quote template configuration interface of the system.

FIG. 10 is a view of one example of one embodiment of an attribute integration interface of the system.

FIG. 11 is a view of one example of one embodiment of a default interface of the example of FIG. 10.

FIG. 12 is a view of one example of one embodiment of a modify interface of the example of FIG. 10, illustrating example process actions.

FIG. 13 is a view of one example of one embodiment of a formula management interface of the system.

FIG. 14 is a view of the formula building blocks of one example of one embodiment of the system.

FIG. 15 is a view of the mathematical operator interfaces of one example of one embodiment of the system.

FIG. 16 is a view of an empty formula block of one example of one embodiment of the system.

FIG. 17 is a view of the example of FIG. 16, illustrating the inclusion of a mathematical component identifier in the formerly empty building block.

FIG. 18 is a view of the example of FIG. 17, illustrating the component delete or removal link.

FIG. 19 is a view of the example of FIG. 17, illustrating the end result of a saved formula.

FIG. 20 is a view of one example of one embodiment of the quote attribute list, which includes mathematical component identifiers.

FIG. 21 is a view of one example of one embodiment of the list of mathematical operator identifiers.

FIG. 22 is a view of one example of one embodiment of the mathematical component identifier column, illustrating the selection of a component identifier.

FIG. 23 is a view of one example of one embodiment of the formula column, illustrating the building of a formula.

FIG. 24 is a view of one example of one embodiment of the formula column, illustrating the inclusion of an operator in a formula.

FIG. 25 is a view of one example of one embodiment of the formula column, illustrating the saving of a formula built by an administrator.

### DETAILED DESCRIPTION

### Offering Module

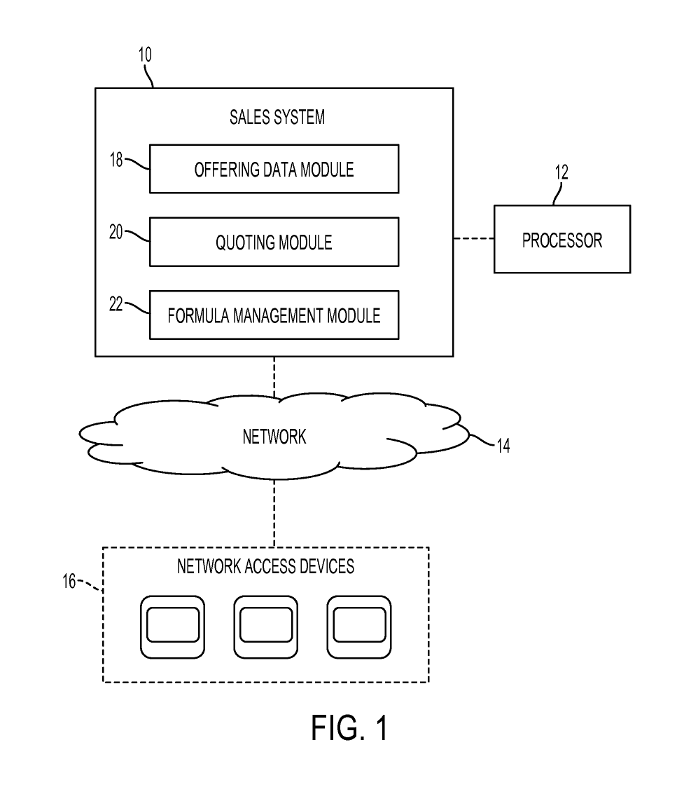

In one embodiment illustrated in FIG. 1, the sales system or system 10 is accessible by a central processing unit (CPU) or a processor 12. The system 10 is also coupled to a data network 14, such as the Internet. Network access devices 16, such as computers, tablets or smartphones, are coupled to the system 10 through the network 14.

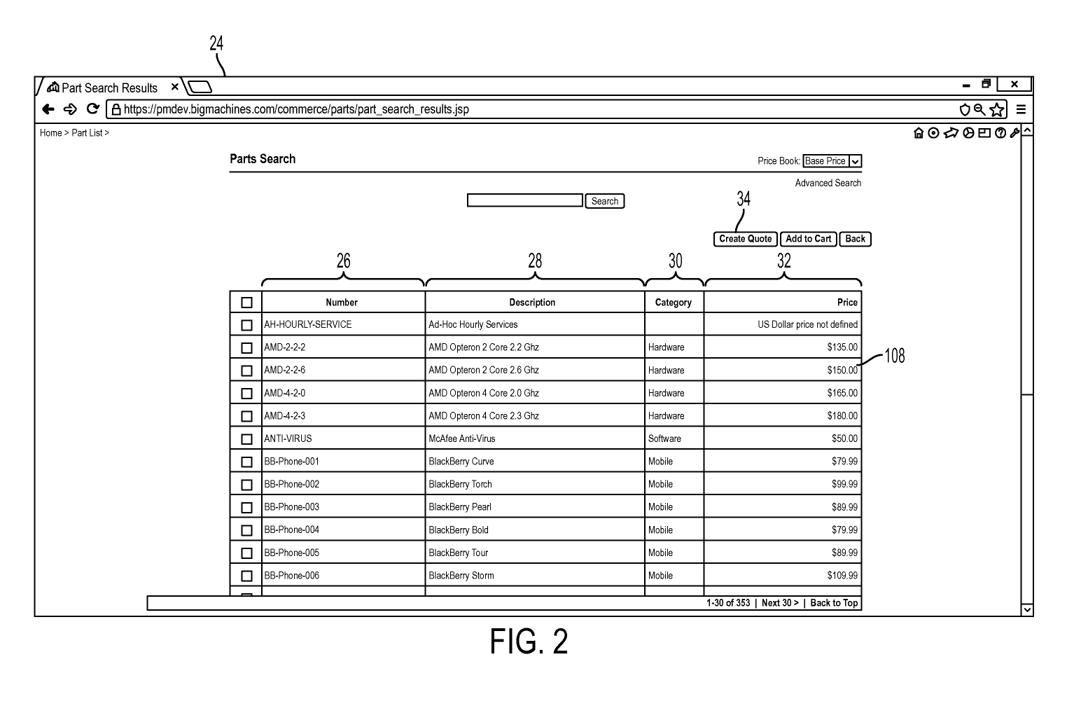

The system 10, in one embodiment, includes an offering data module 18, a quoting module 20 and a formula management module 22. The offering data module 18 includes a plurality of offering data fields fillable with data related to the products or services marketed by a company, organization or other party. For each unique product offering or for each unique stock-keeping unit (SKU) number, the offering data module 18 includes a set of data fields, including, but not limited to, a SKU number data field, description data field, category data field, sell price or list price data field, cost price data field, minimum of quantity (MOQ) data field, unit of measure data field and vendor part number field. An administrative user or administrator can upload or otherwise enter data into the system 10 to fill these data fields with the proper product or service data. In one embodiment, the system 10 displays an offering search interface 24, as illustrated in FIG. 2. In this example, the offering search interface 24 displays the data, provided by the administrator, in the fields of the SKU number column 26, description column 28, category column 30 and sell price or list price column 32.

### Quote Building Template

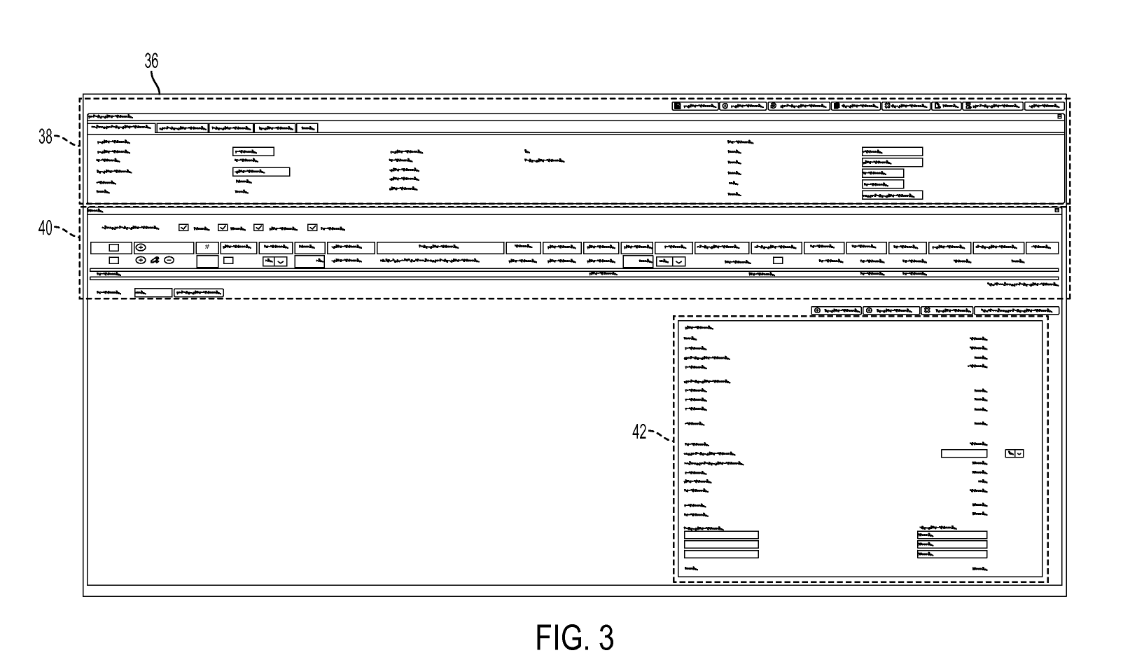

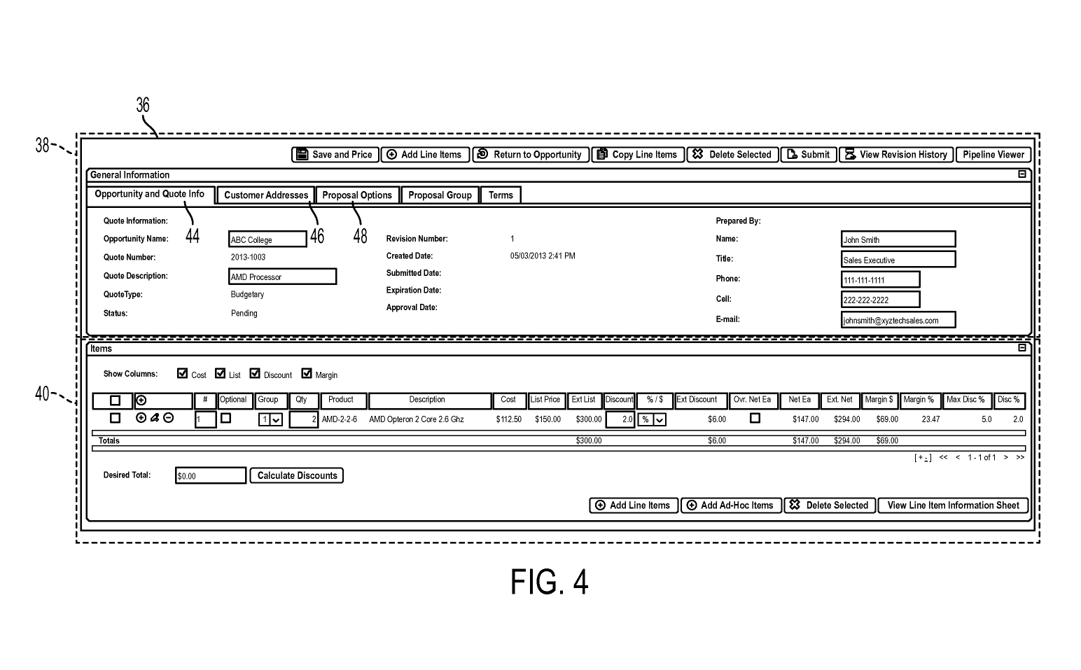

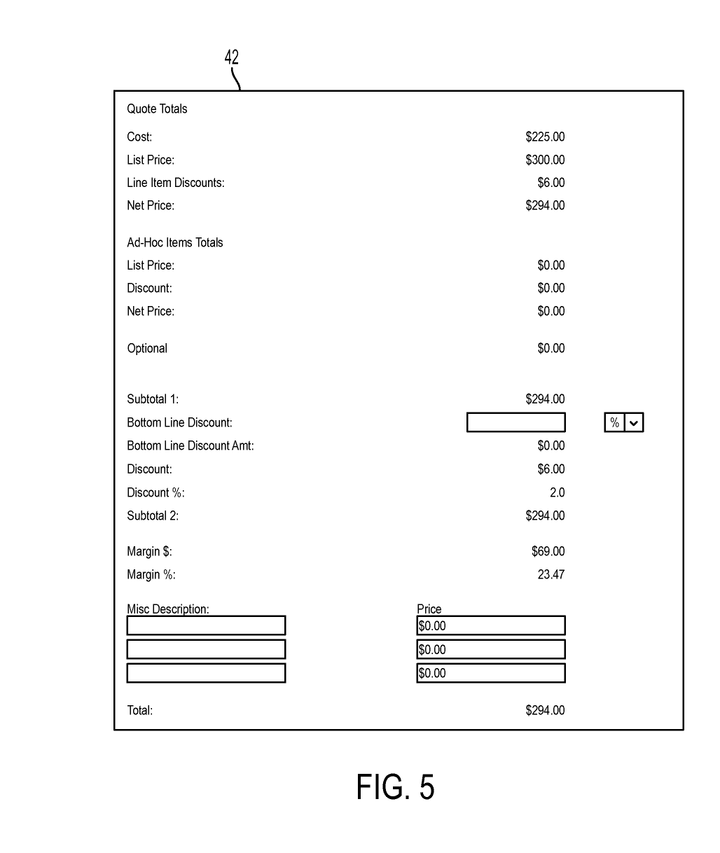

If a potential customer or other party requests a quote for an offering, a sales agent user or sales agent can select the create quote link 34 illustrated in FIG. 2. In response, the system 10 displays an interface or template, such as the quote building template 36 illustrated in FIG. 3. As illustrated in FIGS. 3-5, the quote building template 36 includes a general information section 38, a quote detail section 40, and a quote layout or quote preview 42.

The general information section 38 includes an opportunity and quote section 44. The opportunity and quote section 44 includes a plurality of template data fields fillable with the name of the potential customer or quote requestor, the quote number, a quote description, the quote type, the status of the quote, the quote revision number, the creation date, the quote submission date, the quote expiration date, and the date that the quote was approved by the sales agent's supervisor.

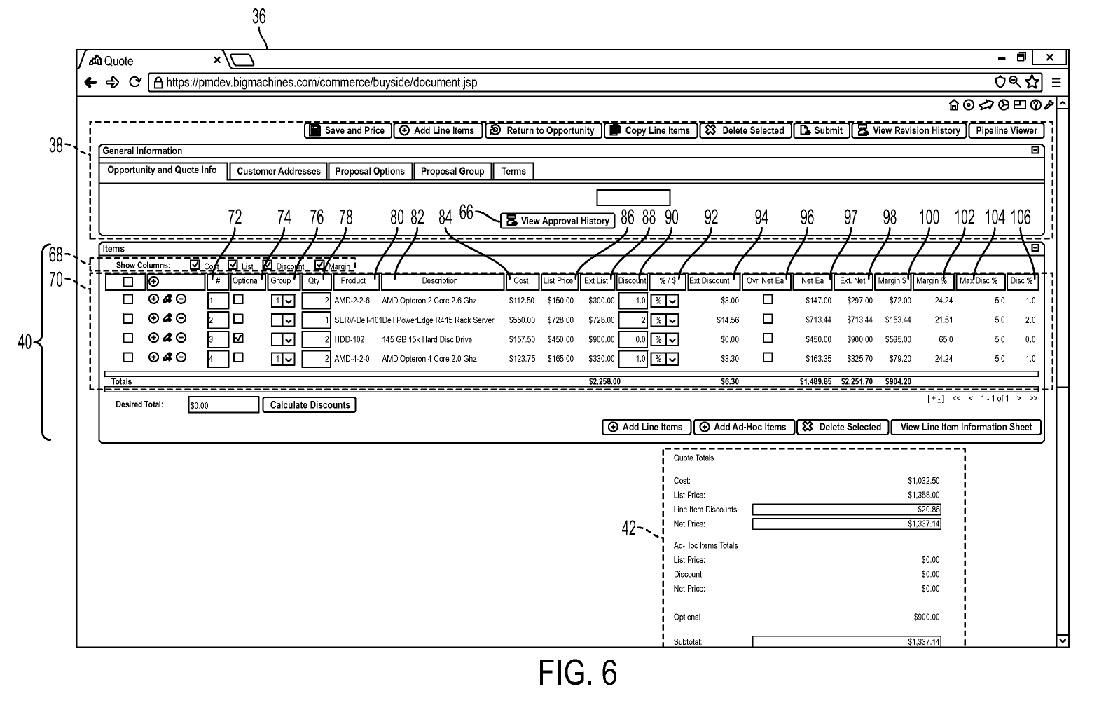

Referring to FIG. 6, the items section 40 includes a show columns section 68, which enables the sales agent to choose which columns to be included in the quote detail interface section 70. In the example shown, the show columns section 68 displays optional columns, including cost, list price, discount and gross profit margin, each of which can be separately selected with the placement of a checkmark as illustrated.

The quote detail interface section 70 includes an item number column 72, an optional column 74, a group column 76, a quantity column 78, a product column 80, a description column 82, a cost column 84, a list price column 86, an extended list price column 88, a discount column 90, a discount form (percentage or dollar) column 92, an extended discount column 94, an override net each column 96, a net each column 97, an extended net column 98, a margin dollars column 100, a margin percentage column 102, a maximum discount percentage column 104 and a discount percentage column 106. Each of these columns provides a unique data capture or data field for each line item to be included in the quote output or quote.

In the example shown, the sales agent places a checkmark in the optional column 74 for item number three. In response, the system 10 indicates that item as an “option” in the quote preview 42. The sales agent also sets group number one, the processor group, for item numbers one and four. As a result, the system 10 applies the one percent discount pricing to such grouped items. The quantity column 78, specified by the sales agent, displays quantities of two, one, two and two for items one, two, three and four, respectively.

The product column 80 displays the SKU codes for the four items. The description column 82 displays the description of the products associated with the SKU codes. The cost column 84 displays the cost amounts for procuring the products. In one embodiment, the quote detail section 70 displays empty data fields under the product column 80. When the sales agent enters a letter, the system 10 displays an alphabetical list of the products stored in the offering data module 18. When the sales agent selects one of the listed products, the system 10 pulls the associated description and cost price data from the offering data module 18.

For item one of the example shown, the sales agent selects AMD-2-2-6. In response, the system 10 displays AMD Opteron 2 Core 2.6 Ghz in the description column 82, and the system 10 displays $112.50 in the cost column 84. The system also displays the list price of $150.00, which corresponds to the list price 108 shown in FIG. 2. In this example, the sales agent specifies a quantity of two in the quantity column 78. The system 10 performs a plurality of calculations based on a plurality of formulas as controlled by the formula management module 22 described below. The system 10 calculates the extended list price of $300.00, as displayed in the extended list price column 88. In this example, the calculation is based on the formula of $150.00×2=$300.00. The sales agent enters a discount of one percent in the discount column 90. The system 10 calculates the extended discount of $3.00, as displayed in the extended discount column 94. In this example, the calculation is based on the formula of $300.00×1%=$3.00. The system 10 calculates the net each price of $148.50, as displayed in the net each column 97. In this example, the calculation is based on the formula of $150−($150×1%)=$148.50. The system 10 calculates the extended net of $297.00, as displayed in the extended net column 98. In this example, the calculation is based on the formula of $148.50×2=$297.00. The system 10 calculates the margin amount of $72.00. In this example, the calculation is based on the formula of $297.00−($112.50×2)=$72.00. The system 10 calculates the margin percentage of 24.24%, as displayed in the margin percentage column 102. In this example, the calculation is based on the formula of ($72.00/$297.00)×100=$24.24%. The system 10, based on settings provided by an administrator, displays the maximum permitted discount percentage of five percent in the maximum discount percentage column 104. If the sales agent desires to give a discount over five percent, the sales agent must obtain approval. In this example, the sales agent gives a discount of one percent, as displayed in the discount percentage column 106.

If the sales agent places a checkmark in the override net each column 96, the system 10 enables the agent to enter or type a desired dollar amount in the net each column 97. In such case, the amount entered by the agent overrides any other net each price calculated by the system 10.

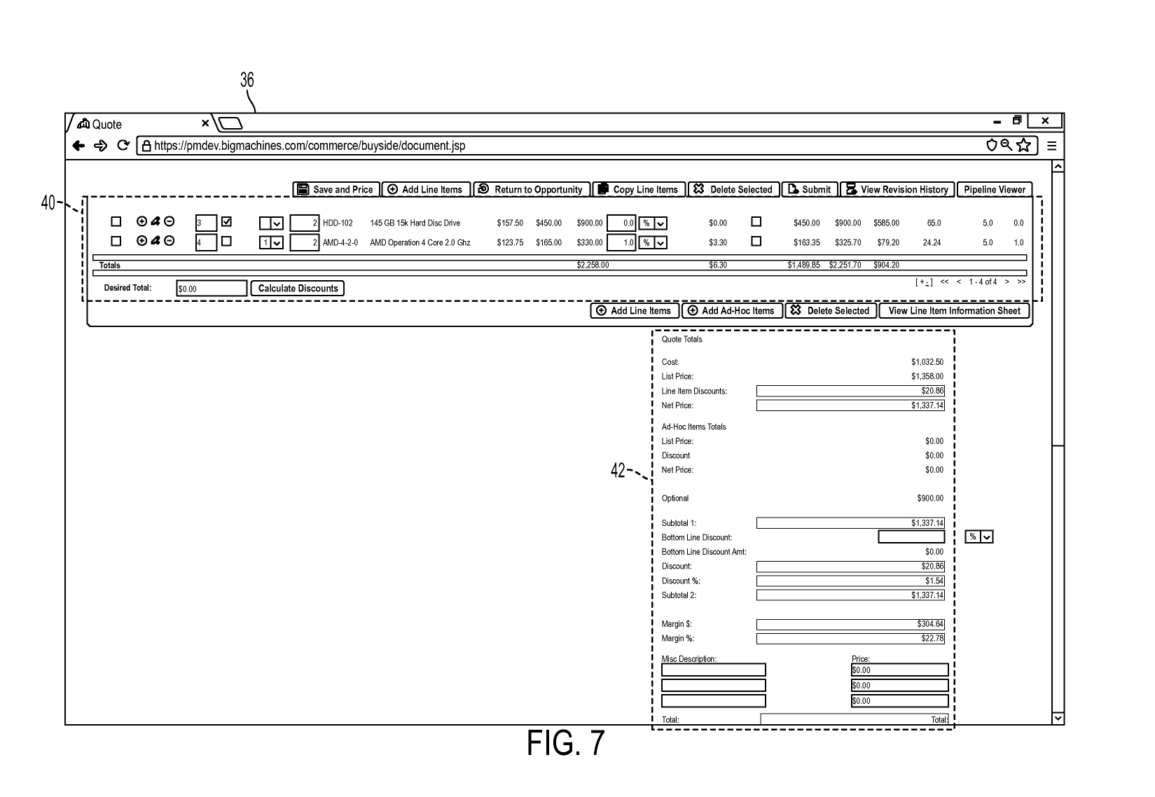

This logic described for item number one also applies to items two, three and four shown in FIG. 6. It should be appreciated that the product data and financial information shown in FIG. 6 is an example. As the sales agent enters data in the quote detail section 70, the system 10 populates the quote preview 42 with the data from the quote detail section 70, as illustrated in FIG. 7.

### Mathematical Components & Formulas

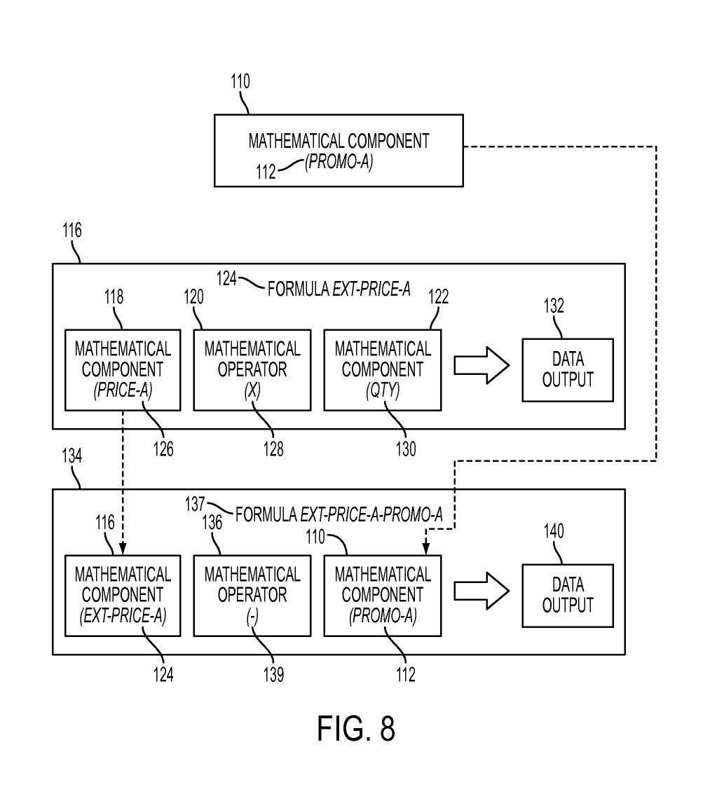

Referring to FIG. 8, the formula management module 22, illustrated in FIG. 1, enables the administrator to build a plurality of mathematical components. Depending upon the embodiment, a mathematical component can include a formula, algorithm, variable, constant, value, function, argument, condition or any other parameter or form of logic. In the example shown, the mathematical component 110 is a constant or value of $10. The component identifier 112, “Promo-A,” identifies the component 110. In this example, the component identifier 112 indicates a promotional discount.

A formula, built through the formula management module 22, can include one or more mathematical components and one or more mathematical operators. In the example shown in FIG. 8, the formula 116 includes mathematical component 118, mathematical operator 120 and mathematical component 122. The formula identifier 124, “Ext-Price-A,” identifies the formula 116. In this example, the mathematical component 118 is the list price, indicated by component indicator 126, “Price-A.” The mathematical operator 120 is the multiplication operator, indicated by operator indicator 128, “X.” The mathematical component 122 is the quantity of product units to be quoted, indicated by component indicator 130, “Qty.” For example, a product has a list price of $150.00, and the quantity to be quoted is two. The system 10 applies the formula 116 to determine $300.00 as the result or data output 132.

In those cases in which a mathematical component is a formula, it should be understood that a formula can include or incorporate one or more other formulas. In one example shown in FIG. 8, the formula 134 includes and incorporates the formula 116, the mathematical operator 136 and the mathematical component 110. The formula identifier 137, “Ext-Price-A-Promo-A,” identifies the formula 134. In this example, the mathematical component or formula 116 generates the output of $300.00. The mathematical operator 136 is the subtraction operator, indicated by operator indicator 139, “−.” The mathematical component 110 is the promotional discount of $10.00. The system 10 applies the formula 134 to subtract $10.00 from $300.00, resulting in $290.00 as the result or data output 140.

### Setup of Mathematical Component Identifiers

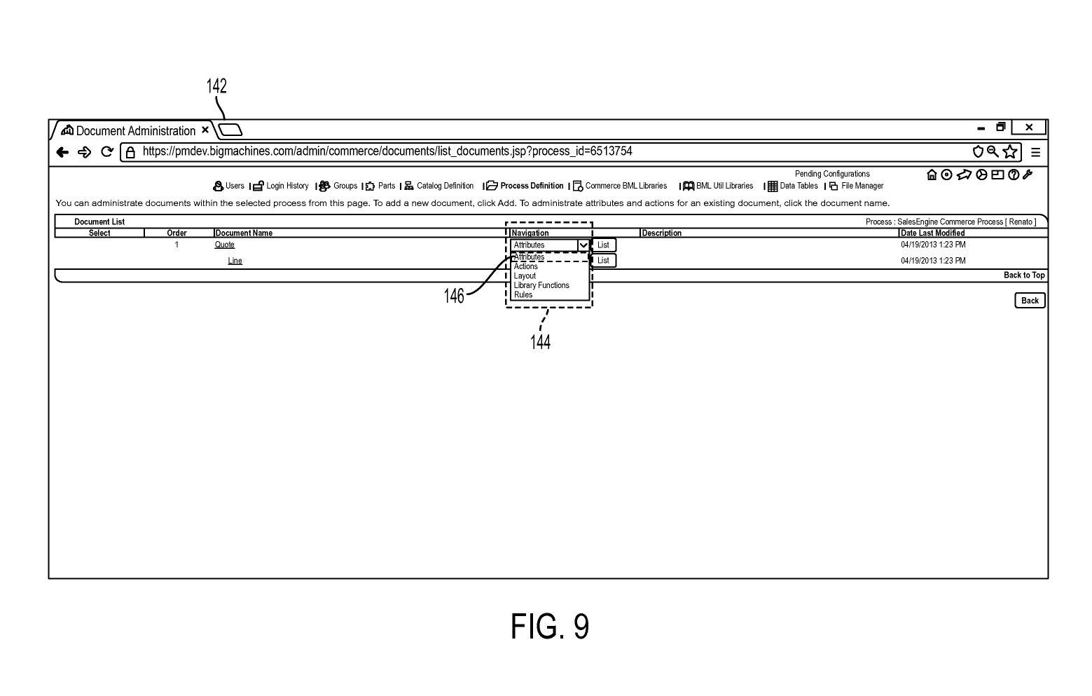

In one embodiment illustrated in FIG. 9, the system 10 displays a quote template configuration interface 142. The template configuration interface 142 enables the administrator to integrate quote attributes into the quote building template 36. The template configuration interface 142 displays a pull-down menu 144. The pull-down menu 144 displays a plurality of links associated with configuring a quote template, including Attributes, Actions, Layout, Library Functions and Rules.

If the administrator selects the Attributes link 146, the system 10 displays a library or list of quote attributes. The list of quote attributes includes general identifiers and mathematical component identifiers. Some of the general identifiers are unrelated to mathematical formulas. For example, the general identifiers include “Name,” “Address,” “Phone Number,” “Title,” “Email,” and “Quote Description.” In contrast, the mathematical component identifiers, such as “Total Quote,” have a functional role in the formulas as described below.

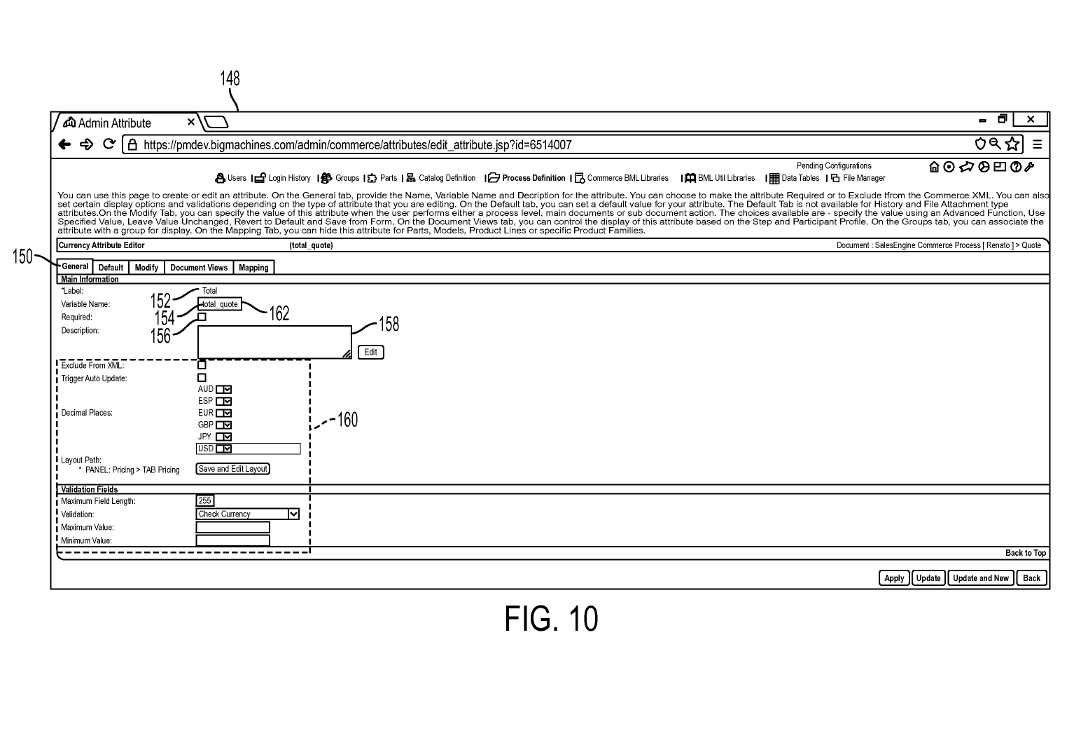

When the administrator selects one of the listed attributes, the system 10 displays the attribute integration interface 148 as illustrated in FIG. 10. The attribute integration interface 148 includes a general interface 150. The general interface 150 displays a plurality of attribute data fields, including a label field 152, variable name field 154 for the quote attribute, required option field 156, description field 158 and a plurality of additional fields 160 related to the following: exclusion from Extensible Markup Language (XML) code, auto updating, currency types, decimal places, layout path and validation. In the example shown, the administrator enters “Total” as the label in the label field 152. The administrator enters “total_quote” as the mathematical component identifier 162 in the variable name field 154.

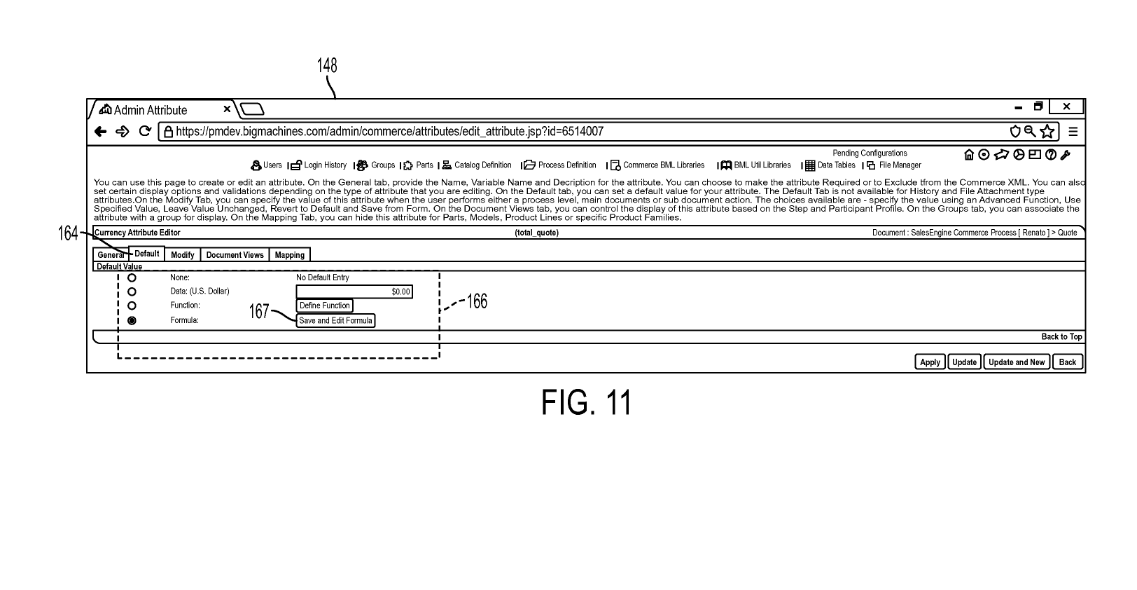

The attribute integration interface 148 also includes a default interface 164 as illustrated in FIG. 11. The default interface 164 displays a plurality of optional settings 166 for the default value of the mathematical component identifier 162. In this embodiment, the optional settings include None, Data (US Dollar), Function and Formula. To specify a value for the mathematical component identifier 162, the administrator may select the Data setting and enter a monetary value in the value data field 164. To couple the mathematical component identifier 162 to a formula, the administrator may select the save and edit formula link 167 adjacent to the Formula setting. This will launch the formula management module 22 described below.

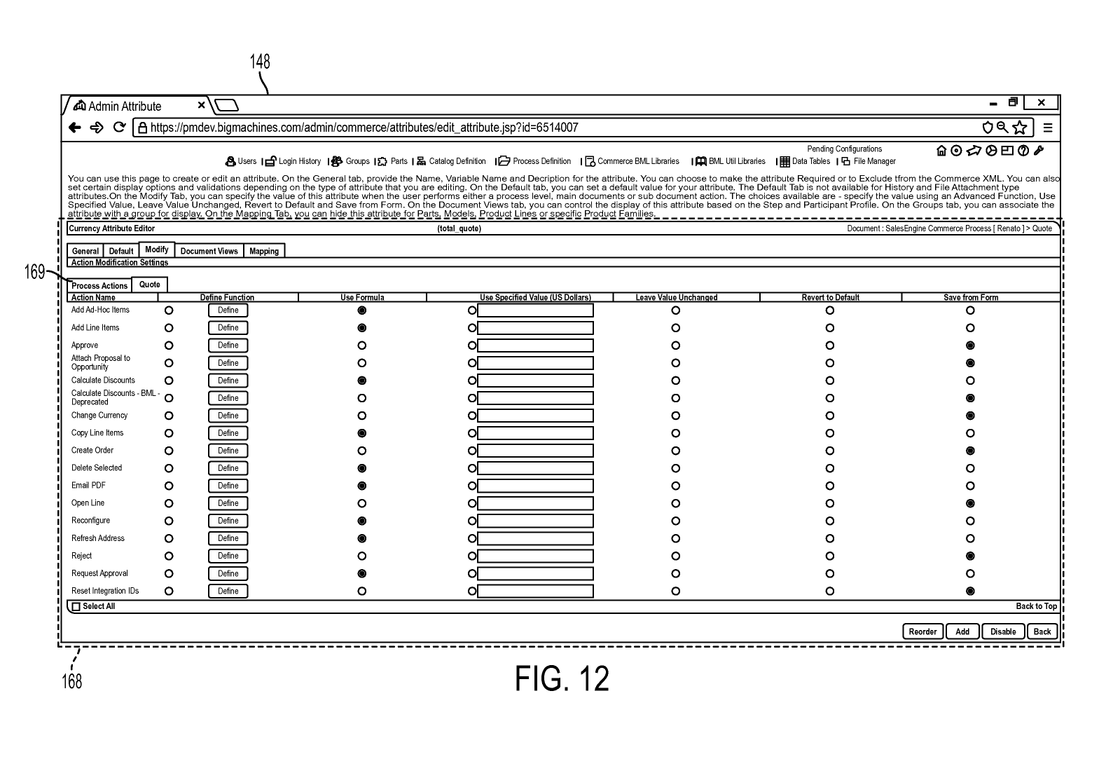

As illustrated in FIG. 12, the modify interface 168 of the attribute integration interface 148 displays a plurality of process actions 169. Each process action 169, if selected, functions in conjunction with the mathematical component identifier 162 in the quote building template 36. The modify interface 168 displays a plurality of items associated with each process action 169, including a define link, use formula option, use specified value field, leave value unchanged option, revert to default option, and save from form option. By selectively configuring these items, the administrator can specify the settings for each process action 169.

### Formula Management Module

As described above, the quote template configuration interface 142 and attribute integration interface 148 enable the administrator to setup a plurality of quote attributes. The quote attributes include general identifiers and mathematical component identifiers, such as mathematical component identifier 162, “total_quote,” shown in FIG. 10. After the mathematical component identifiers have been setup, the administrator may proceed to build formulas based on the mathematical component identifiers.

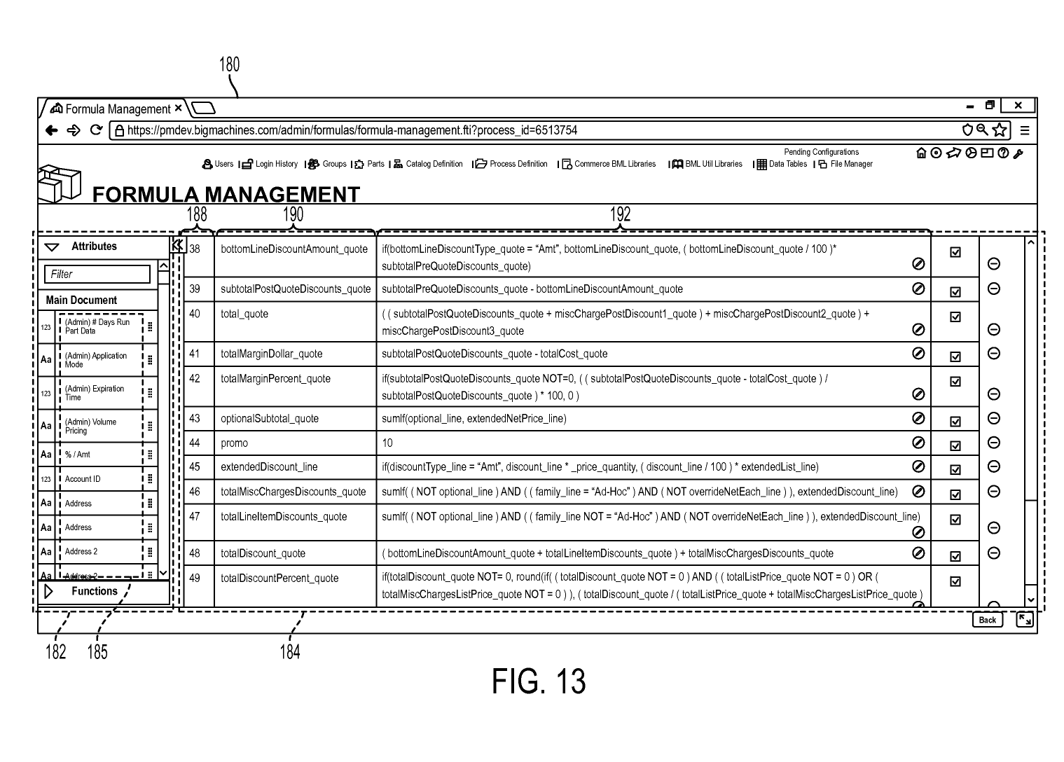

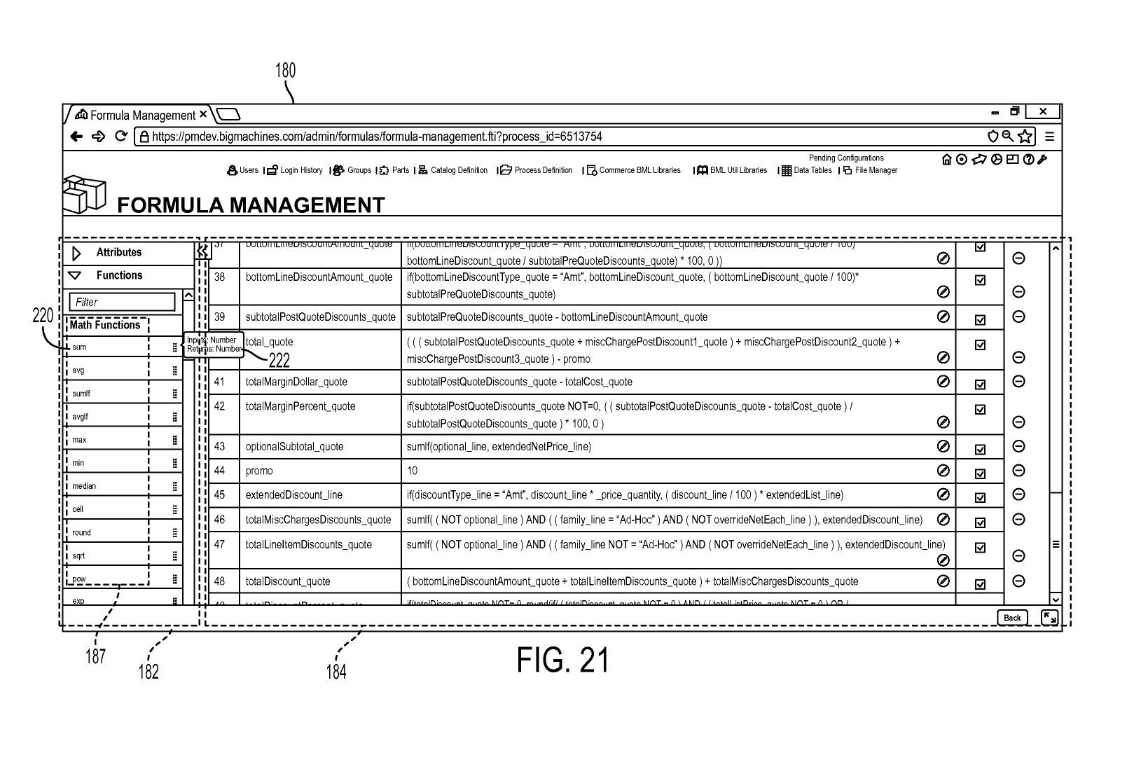

For formula building, the system 10 displays a formula management interface 180, as illustrated in FIG. 13, in accordance with the formula management module 22. In one embodiment, the formula management interface 180 includes a library list section 182 and a formula management section 184. The library list section 182 displays a scrollable, alphabetical list of the labels of all of the attributes or mathematical component identifiers 185 setup by the administrator. As illustrated in FIGS. 13 and 21, the library list section 182 also displays a scrollable, alphabetical list of all of the mathematical functions or mathematical operator identifiers 187.

In one embodiment, the administrator sets-up the identifiers 185 through the attribute integration interface 148. In another embodiment, the system 10 is prepopulated with one or more of the identifiers 185 and 187.

Referring back to FIG. 13, the formula management section 182 displays a formula list 188. The formula identification column 188 displays a unique code or number for each of the different formulas. The reference column 190 displays the mathematical component identifiers 185. The mathematical component identifiers 185 are insertable into the quote through the integration process described above. The formula column 192 displays the formulas or other mathematical components.

In one embodiment, the system 10 is prepopulated with a library of customizable formulas, such as the formulas shown in FIGS. 13-25. The administrator may use the formulas without modification. Alternatively, the administrator may edit the formulas as described below, delete the formulas, or add new formulas.

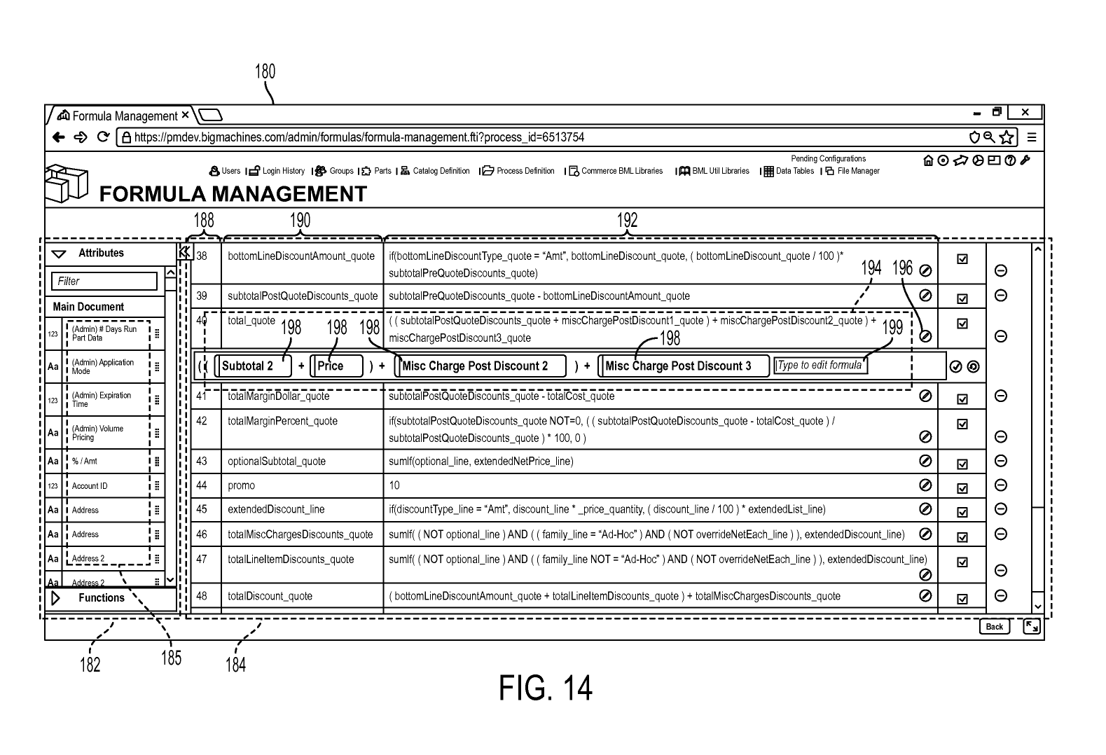

In one example illustrated in FIG. 14, the administrator edits formula 194 by selecting the edit link 196. The system 10 then displays the four building blocks 198 which correspond to the four mathematical components of the formula 194. The system 10 also displays the addition operator in three places. Also, the system 10 displays an empty block field 199 at the right end of the chain of blocks 198. When building or editing a formula, such as formula 194, the system 10 enables the administrator to enter parentheses in the desired order to establish the proper order of operations for the mathematical calculation. In one embodiment, the user may add a parenthesis by holding the shift key and pressing the desired parenthesis key of a computer or other network access device.

To add attributes or mathematical component identifiers 185 to a formula 194, the system 10 enables the administrator to drag a desired identifier 185 from the library list section 182 to the formula 194.

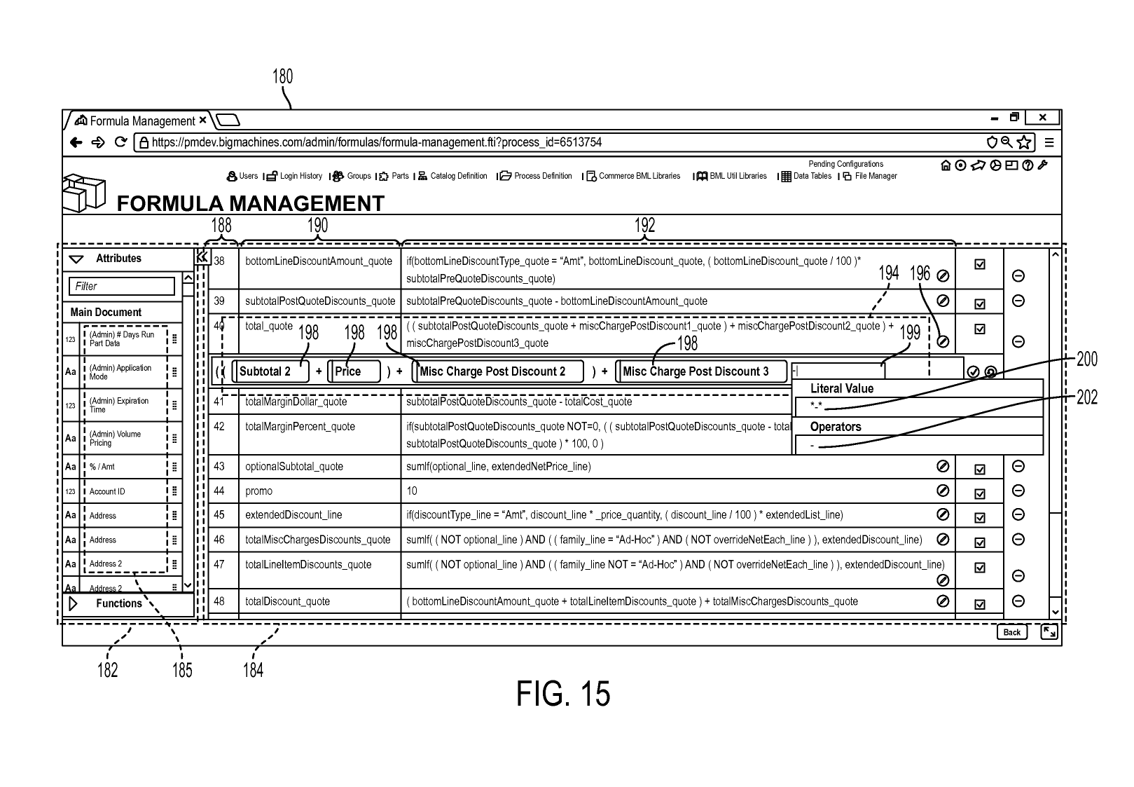

Referring to FIG. 15, if the administrator enters an operator in the block field 199, such as a minus sign, the system 10 displays a selectable literal value or dash 200. The system 10 also displays a selectable subtraction operator 202. If the administrator selects the dash 200, the system 10 will enter the dash into the formula 194, but the dash will not have a mathematical function or purpose. If the administrator selects the subtraction operator 202, the system 10 will enter the minus sign into the formula 194, and the minus sign will have a subtraction function.

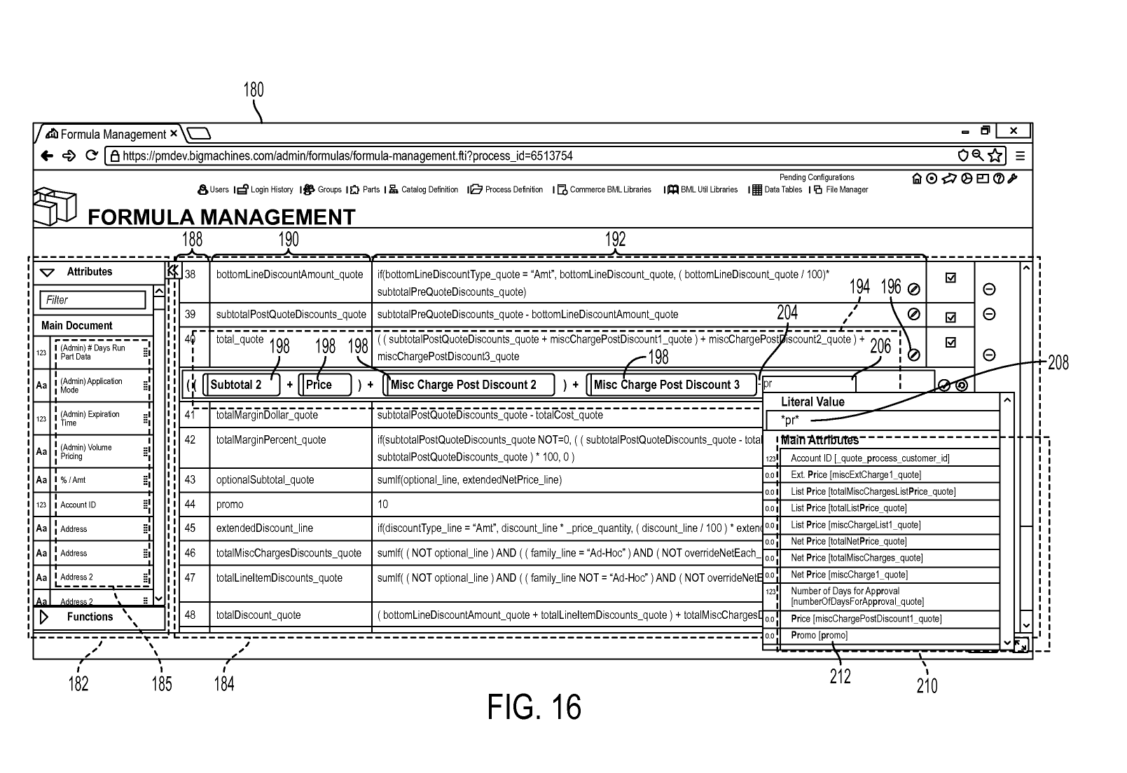

In this example, the administrator selects the subtraction operator 202, and the system 10 enters the subtraction operator identifier 204 into the formula 194, as illustrated in FIG. 16. The system 10 then displays a block field 206 at the right end of the chain of blocks 198, to the right of the subtraction operator identifier 204. At this time, the administrator desires to add a mathematical component to the formula 194. The administrator enters “pr” into the block field 206. The system 10 then displays a selectable literal value 208 of “pr.” Based on the search logic of the formula management module 22, the system 10 also displays an alphabetic list 210 of attributes or mathematical component identifiers which begin with or include “pr.”

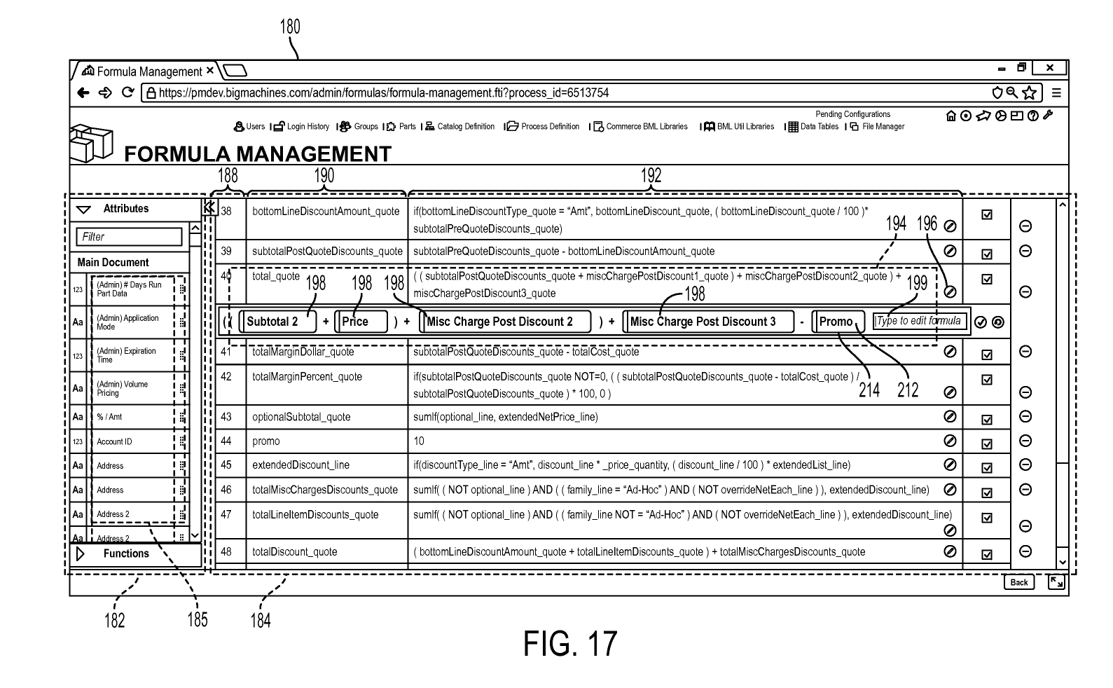

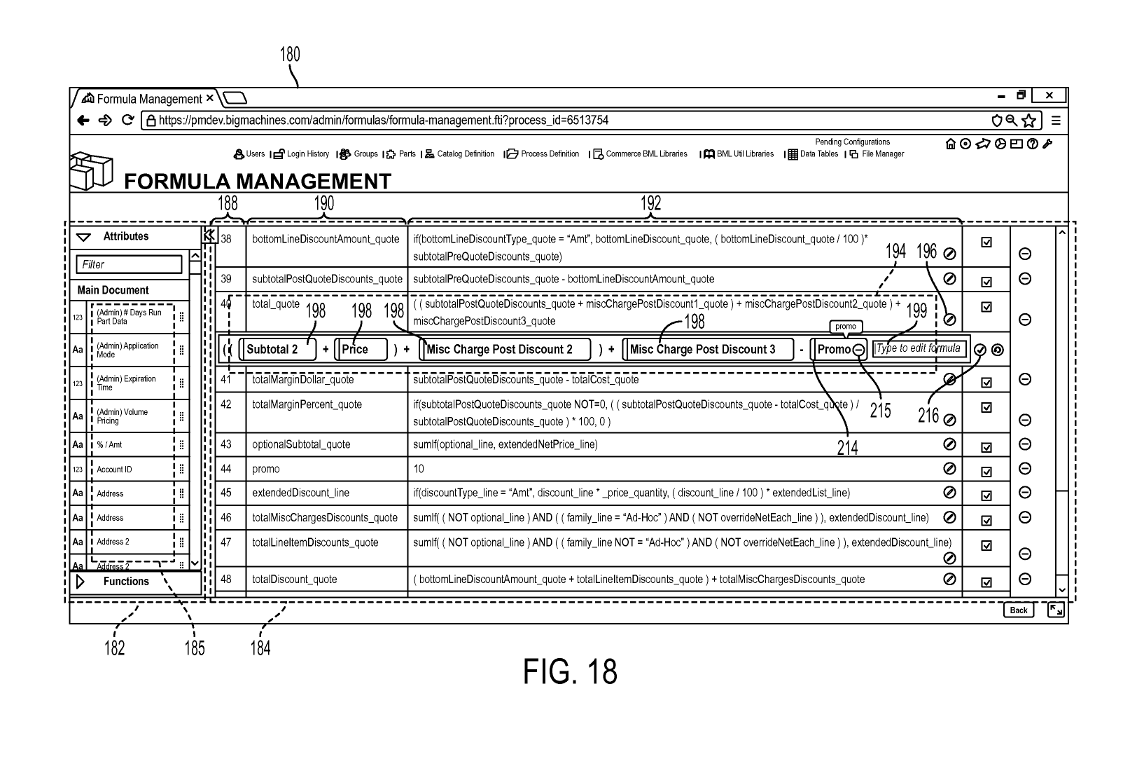

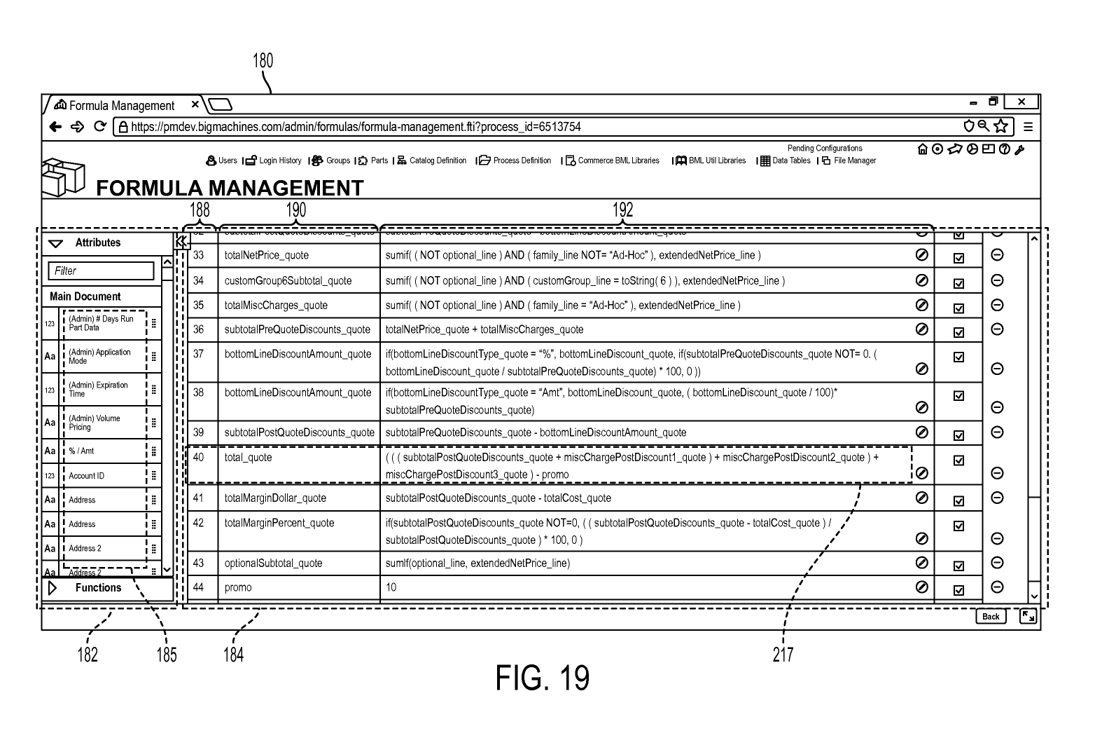

In this example, as illustrated in FIGS. 16-17, the administrator selects the “promo” identifier 212. The system 10 then adds to the block chain, block 214 for the identifier 212. Referring to FIG. 18, if the administrator desires to delete or remove block 214, the administrator may click on the block 214. The system 10 then displays within the block 214, a white dash in a red circle 215. If the administrator were to select the red circle 215, the system 10 would remove the block 214 from the formula 194. In this example, the administrator choses to keep the block 214. The administrator then clicks the save link 216. In response, the system 10 hides the chain of blocks and displays the textual version 217 of the formula 194 as illustrated in FIG. 19.

In one embodiment, referring back to FIG. 17, the system 10 generates the blocks and operator identifiers in the order or sequence in which the administrator enters them. In one example, the administrator selects component identifiers and operator identifiers in the following sequence: (R−(Q+Z))+(B−F). In this example, the system 10 incrementally displays the blocks, from left to right, as follows:

(R Block−(Q Block+Z Block))+(B Block−F Block)

In an alternative embodiment, the system 10 enables the administrator to click on, select or otherwise activate each block. After doing so, the system 10 enables the administrator to drag an activated block to a different position relative to the other blocks. For example, in this alternative embodiment the administrator may drag the F Block to the left of the B Block, changing the order to the following:

(R Block−(Q Block+Z Block))+(F Block−B Block)

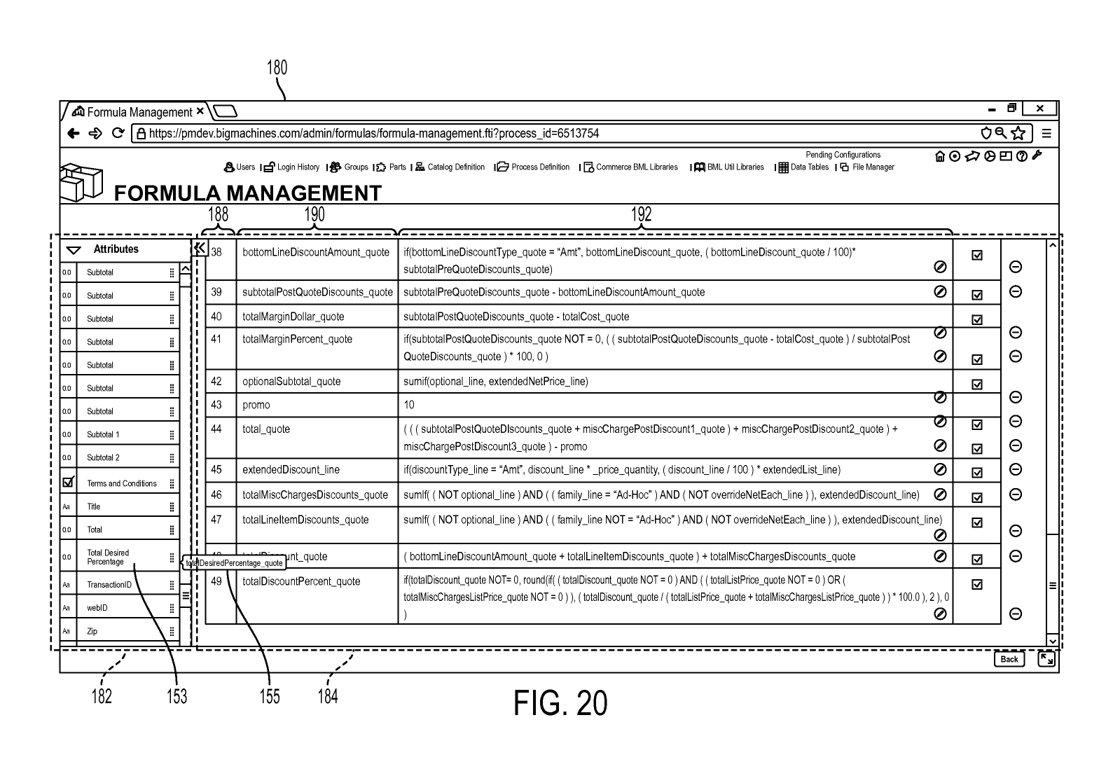

If the administrator desires to build an entirely new formula, the administrator may refer to the library list section 182. Within that list, the administrator can locate, and take note of, a desired mathematical component identifier. In the example shown in FIG. 20, the administrator locates the total desired percentage label 153. When the administrator hovers over or activates the total desired percentage label 153, the system generates a popup display 155. The popup display 155 states the mathematical component identifier, “totalDesiredPercentage_quote.” To include that identifier in a formula, the administrator can drag the total desired percentage label 153 into the formula column 192.

Within the list section 182, the administrator can locate, and take note of, a desired mathematical operator identifier. In the example shown in FIG. 21, the administrator locates the addition or sum operator identifier 220 associated with the sum logic 222 of “Inputs: Number and Returns: Number.” With this in mind, when the administrator proceeds to build a new formula, the administrator may enter List or totalList into the identifier field in the reference column 190. While building the formula in the fashion described above, the administrator can enter “sum” to include a sum function.

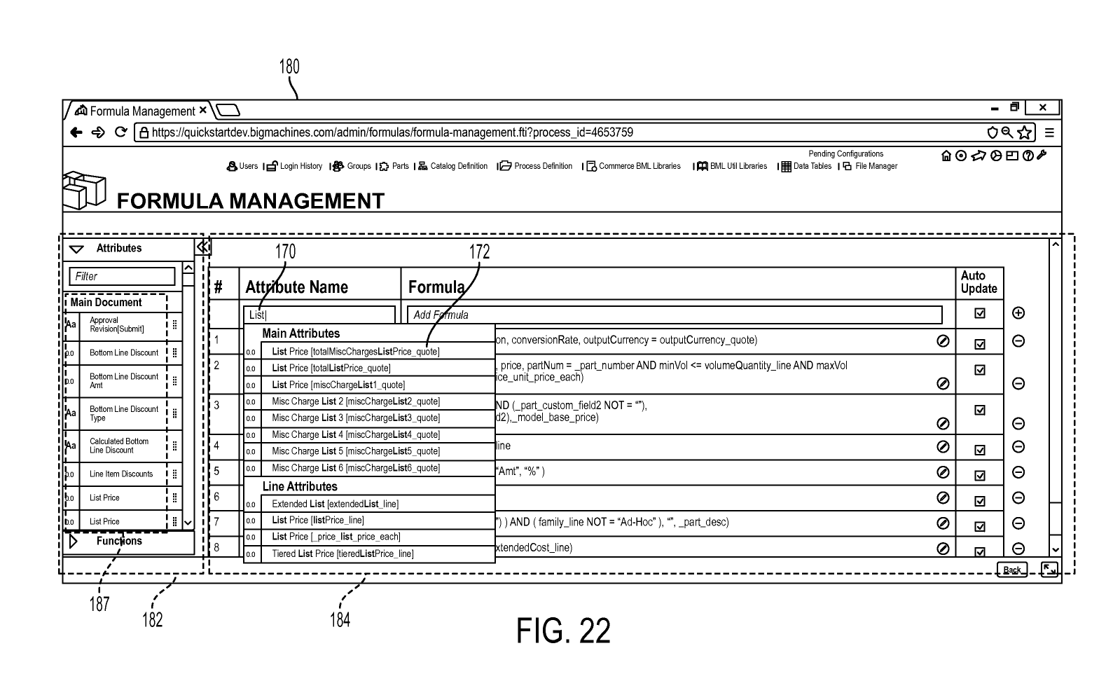

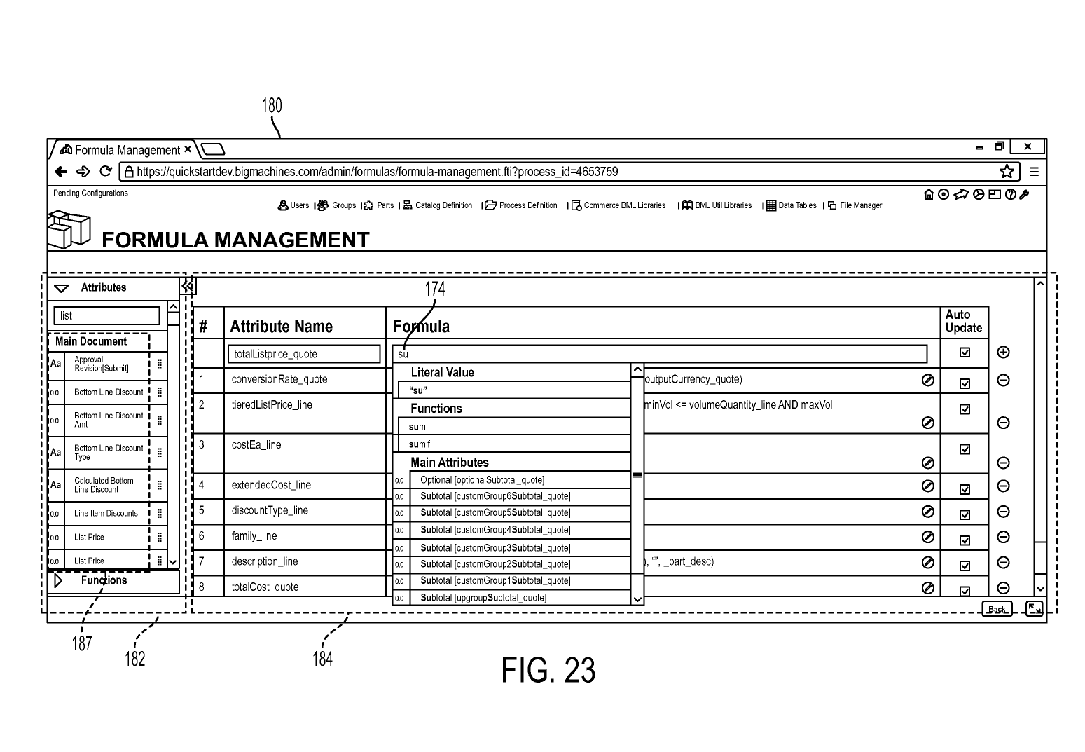

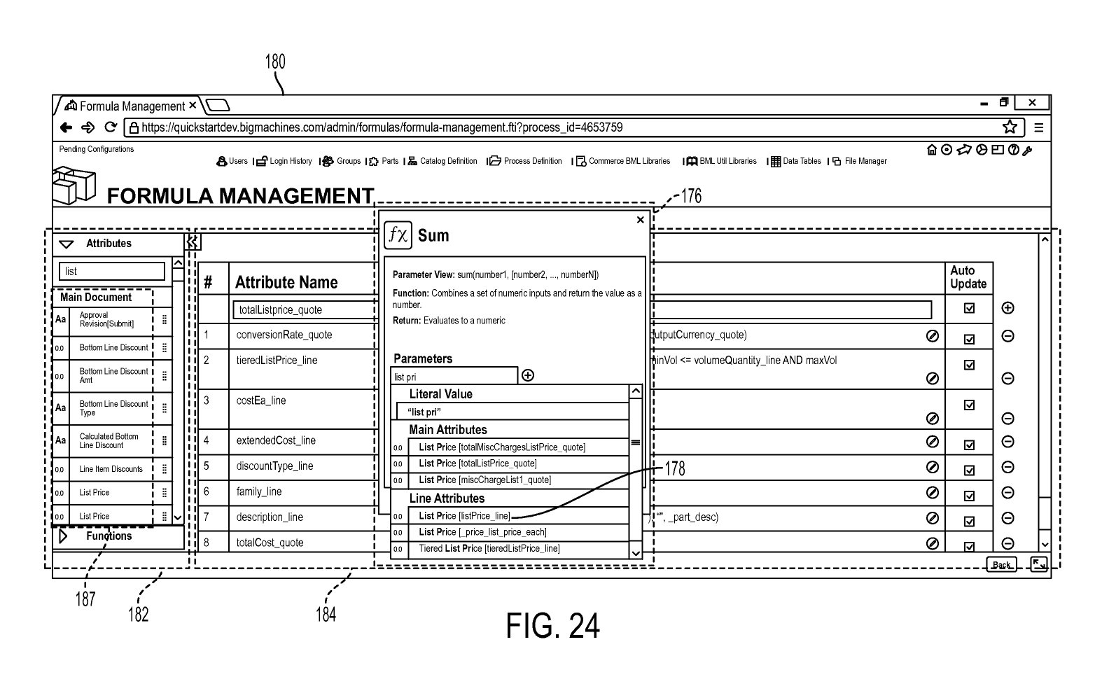

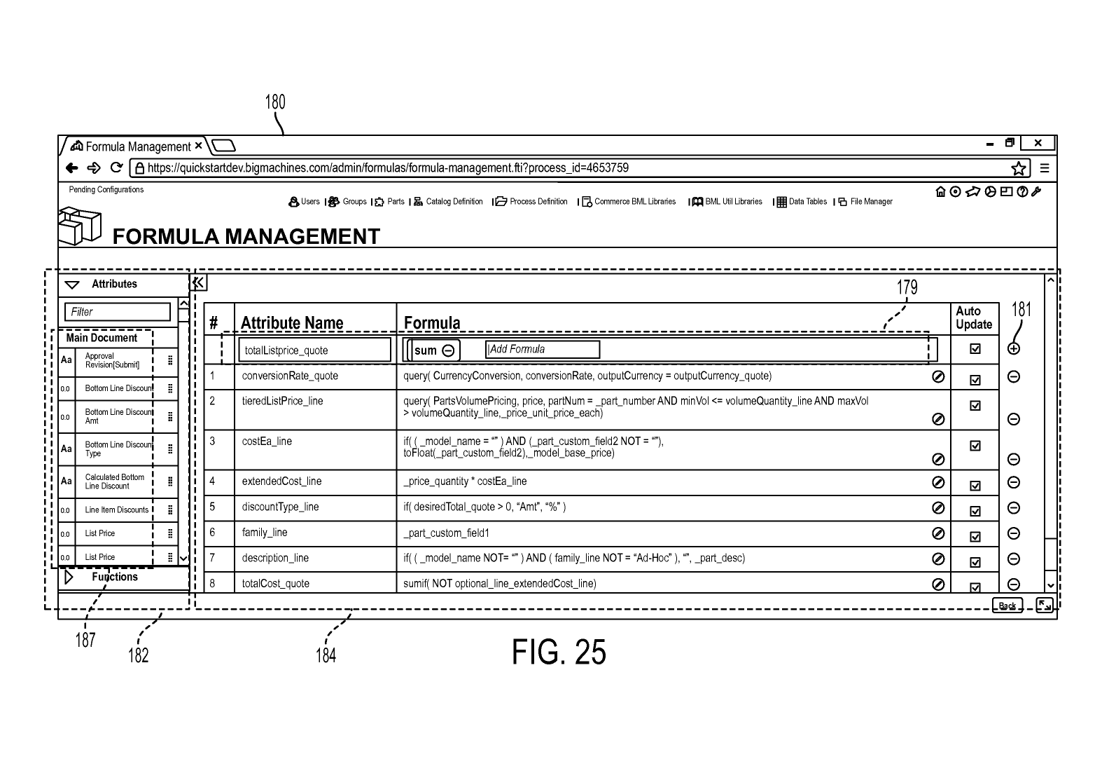

In one example illustrated in FIGS. 22-25, the administrator enters a new formula. In the reference column 190, the administrator types the initial letters of the word, “list” 170. The system 10 automatically displays an alphabetical list of the mathematical component identifiers and labels which contain the letters entered, as illustrated in FIG. 22. For the List Price label, the administrator selects the “totalListPrice_quote” identifier 172. In the formula column 192 shown in FIG. 23, the administrator enters the initial letters 174 of the word, “sum.” The system 10 automatically displays an alphabetical list of the mathematical operator identifiers, functions, and literal values which contain the letters entered, as illustrated in FIG. 23. The administrator then selects the “sum” identifier. As illustrated in FIG. 24, the system 10 automatically displays a function popup window 176 asking for the mathematical operator identifier to be summed. The administrator selects the “listPrice_line” identifier 178. At this point, the administrator can save the formula 179 by selecting the save link 181 as illustrated in FIG. 25.

In one embodiment, the system 10 includes an access control module. The access control module specifies a plurality of different user profiles, including an administrator profile and a sales agent profile. The administrator profile is associated with complete access to all settings, functionality and visibility of the system 10, including, but not limited to, the use of the formula management interface 180. The sales agent profile is associated with restricted access which is limited to the use of the quote building template 36. This provides security for the protection and integrity of the formulas.

### Methods

In one embodiment, the system 10 is implemented as a method. The method includes the following steps:
(a) electronically storing a plurality of computer-readable instructions; and
(b) electronically executing the computer-readable instructions to:
   i. cause one of the formula identifiers to be displayed, wherein the formula identifier is associated with a formula;
   ii. cause a plurality of mathematical component identifiers to be displayed, wherein the mathematical component identifiers are associated with a plurality of mathematical components;
   iii. receive a sequence of selections for a user's building of the formula, wherein the selections include a plurality of the component identifiers and at least one of a plurality of formula operator identifiers;
   iv. cause the formula to be displayed according to the sequence, wherein the formula displays the selected component identifiers and the operator identifier;
   v. repeat steps (i) through (iv) for the user's building of another formula; and
   vi. display a list of the formula identifiers.

### Network

Referring to FIG. 1, the network 14 can be any suitable type of network. Depending upon the embodiment, the network 14 can include one or more of the following: a wired network, a wireless network, a local area network (LAN), an extranet, an intranet, a wide area network (WAN) (including, but not limited to, the Internet), a virtual private network (VPN), an interconnected data path across which multiple devices may communicate, a peer-to-peer network, a telephone network, portions of a telecommunications network for sending data through a variety of different communication protocols, a Bluetooth communication network, a radio frequency (RF) data communication network, an infrared (IR) data communication network, a satellite communication network or a cellular communication network for sending and receiving data through short messaging service (SMS), multimedia messaging service (MMS), hypertext transfer protocol (HTTP), direct data connection, Wireless Application Protocol (WAP), email or any other suitable message transfer service or format.

### Hardware

Referring to FIG. 1, in one embodiment, the system 10 includes a single server. In another embodiment, the system 10 includes multiple servers, each of which implements a different part of the system 10. In one embodiment, each of the one or more servers includes: (a) a processor (such as the processor 12) or a central processing unit (CPU); and (b) one or more data storage devices, including, but not limited to, a hard drive with a spinning magnetic disk, a Solid-State Drive (SSD), a floppy disk, an optical disk (including, but not limited to, a CD or DVD), a Random Access Memory (RAM) device, a Read-Only Memory (ROM) device (including, but not limited to, programmable read-only memory (PROM), erasable programmable read-only memory (EPROM), electrically erasable programmable read-only memory (EEPROM)), a magnetic card, an optical card, a flash memory device (including, but not limited to, a USB key with non-volatile memory, any type of media suitable for storing electronic instructions or any other suitable type of computer-readable storage medium.

In one embodiment, each of the one or more servers is a general purpose computer. In one embodiment, the one or more servers function to deliver webpages at the request of clients, such as web browsers, using the Hyper-Text Transfer Protocol (HTTP). In performing this function, the one or more servers deliver Hyper-Text Markup Language (HTML) documents and any additional content which may be included, or coupled to, such documents, including, but not limited, to images, style sheets and scripts.

The network access devices 16 can include any device operable to access the network 14, including, but not limited to, a server, personal computer (PC) (including, but not limited to, a desktop PC, a laptop or a tablet), smart television, Internet-enabled TV, person digital assistant, smartphone, cellular phone or mobile communication device. In one embodiment, each network access device 16 has at least one input device (including, but not limited to, a touchscreen, a keyboard, a microphone, a sound sensor or a speech recognition device) and at least one output device (including, but not limited to, a speaker, a display screen, a monitor or an LCD).

### Software

In one embodiment, the servers and network access devices each include a suitable operating system. Depending upon the embodiment, the operating system can include Windows, Mac, OS X, Linux, Unix, Solaris or another suitable computer hardware and software management system. In another embodiment, one or more of the network access devices includes a mobile operating system, including, but not limited to, Android, BlackBerry, iOS, Windows Phone and Windows RT.

In one embodiment, each of the network access devices has a browser operable by their processors to retrieve, present and traverse the following: (a) information resources on the one or more servers of the system 10; and (b) information resources on the World Wide Web portion of the Internet.

In one embodiment, the computer-readable instructions, algorithms and logic of the system 10 (including the computer-readable instructions and logic) are implemented with any suitable programming or scripting language, including, but not limited to, C, C++, Java, COBOL, assembler, PERL, Visual Basic, SQL Stored Procedures or Extensible Markup Language (XML). The modules 18, 20 and 22 of the system 10 can be implemented with any suitable combination of data structures, objects, processes, routines or other programming elements.

In one embodiment, the data storage device of the system 10 holds or stores web-related data and files, including, but not limited, to HTML documents, image files, Java applets, JavaScript, Active Server Pages (ASP), Common Gateway Interface scripts (CGI), XML, dynamic HTML, Cascading Style Sheets (CSS), helper applications and plug-ins.

In one embodiment, the graphical interfaces of the system 10 are Graphical User Interfaces (GUIs) structured based on a suitable programming language. The GUIs include, in one embodiment, windows, pull-down menus, buttons, scroll bars, iconic images, wizards, a mouse symbol or pointer, and other suitable graphical elements. In one embodiment, the GUIs incorporate multimedia, including, but not limited to, sound, voice, motion video and virtual reality interfaces.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A system comprising:
a data storage device configured to store data associated with: (a) a plurality of different mathematical components; (b) a component identifier associated with each one of the mathematical components; (c) a plurality of different mathematical operators; (d) an operator identifier associated with each one of the mathematical operators; and (e) a plurality of different formula identifiers, the data storage device being accessible by a processor over a network; and
a plurality of instructions stored within the data storage device, the instructions being executable by the processor to:
(a) cause one of the formula identifiers to be displayed, the formula identifier being associated with a formula;
(b) cause a plurality of the component identifiers to be displayed;
(c) receive a sequence of selections for a user's building of the formula, the selections including a plurality of the component identifiers and at least one of the operator identifiers;
(d) cause the formula to be displayed according to the sequence, the formula displaying the selected component identifiers and the at least one operator identifier;
(e) repeat steps (a) through (d) for the user's building of another formula; and
(f) display a list of the formula identifiers.

2. The system of claim 1, wherein the mathematical components are selected from the group consisting of a variable, a constant, a value, a function, an argument, and a condition.

3. The system of claim 1, wherein each one of the component identifiers includes at least one letter of a word which is at least partially descriptive of the mathematical component associated with the component identifier.

4. The system of claim 1, wherein one of the mathematical components includes one of the formulas.

5. The system of claim 1, wherein a plurality of instructions are executable by the processor to: (a) receive a build formula input from the user; (b) cause a component data field to be displayed in response to the build formula input; (c) receive at least one letter entered into the component data field by the user; (d) in response to the entered letter, cause at least part of a component identifier list to be displayed in alphabetical order, the displayed part including a plurality of the component identifiers which begin with the letter; and (e) receive a selection signal based on the user's pointing to one of the component identifiers in the component identifier list.

6. The system of claim 5, wherein a plurality of instructions are executable by the processor to: (a) cause an operator identifier list to be displayed after at least one of the component identifiers has been selected, the operator identifier list displaying a list of a plurality of the operator identifiers in alphabetical order; (b) receive another selection signal based on the user's pointing to one of the operator identifiers in the operator identifier list.

7. The system of claim 1, wherein a plurality of instructions are executable by the processor to: (a) generate a template, the template having a plurality of different template data fields, the template data fields being associated with different ones of the formulas; (b) mathematically apply the formulas to generate a plurality of data results; and (c) fill the template data fields with the data results.

8. The system of claim 7, wherein a plurality of instructions are executable by the processor to: (a) edit one of the formulas in response to an edit input received from the user; (b) mathematically apply the edited formula to generate a data result; and (c) fill one of the template data fields with the data result.

9. The system of claim 7, wherein the template includes a quote building template.

10. The system of claim 9, wherein the template data fields include a quantity data field, a cost data field, a price data field, a discount data field and a total data field.

11. A system comprising:
a data storage device configured to store data associated with: (a) a plurality of different mathematical components; (b) a component identifier associated with each one of the mathematical components; (c) a plurality of different mathematical operators; (d) an operator identifier associated with each one of the mathematical operators; (e) a plurality of different formula identifiers; and (f) cost of a plurality of different offerings, the data storage device being accessible, over a network, by a processor; and
a formula management instruction set stored within the data storage device, the formula management instruction set including a plurality of instructions which are executable by the processor to:
(a) cause one of the formula identifiers to be displayed, the formula identifier being associated with a formula;
(b) cause a plurality of the component identifiers to be displayed;
(c) receive a sequence of selections for a user's building of the formula, the selections including a plurality of the component identifiers and at least one of the operator identifiers;
(d) cause the formula to be displayed according to the sequence, the formula displaying the selected component identifiers and the at least one operator identifier;
(e) repeat steps (a) through (d) for the user's building of another formula; and
(f) display a formula list, each item in the formula list including one of the formula identifiers and one of the formulas;
a quote building instruction set stored within the data storage device, the quote building instruction set including a plurality of instructions which are executable by the processor to:
(a) cause a quote building template to be displayed, the quote building template having a plurality of different quote data fields, the quote data fields being associated with different ones of the formulas;
(b) mathematically apply the formulas to generate a plurality of data results related to at least one of the offerings;
(c) fill the quote data fields with the data results; and
(d) generate a quote based on the template.

12. The system of claim 11, wherein the offerings are selected from the group consisting of a product and a service.

13. The system of claim 11, wherein a plurality of instructions are executable by the processor to: (a) edit one of the formulas in response to an edit input received; (b) mathematically apply the edited formula to generate a data result; and (c) fill one of the quote data fields with the data result.

14. The system of claim 11, wherein the mathematical components include components selected from the group consisting of a variable, a constant, a value, a function, an argument, and a condition.

15. The system of claim 11, wherein each one of the component identifiers includes at least one letter of a word which is at least partially descriptive of the mathematical component associated with the component identifier.

16. The system of claim 11, wherein a plurality of instructions are executable by the processor to: (a) receive a build formula input from the user; (b) cause a component data field to be displayed in response to the build formula input; (c) receive at least one letter entered into the component data field by the user; (d) in response to the entered letter, cause at least part of a component identifier list to be displayed in alphabetical order, the displayed part including a plurality of the component identifiers which begin with the letter; and (e) receive a selection signal based on the user's pointing to one of the component identifiers in the component identifier list.

17. A method comprising:
electronically storing a plurality of computer-readable instructions; and
electronically executing the computer-readable instructions to:
(a) cause one of the formula identifiers to be displayed, the formula identifier being associated with a formula;
(b) cause a plurality of mathematical component identifiers to be displayed, the mathematical component identifiers being associated with a plurality of mathematical components;
(c) receive a sequence of selections for a user's building of the formula, the selections including a plurality of the component identifiers and at least one of a plurality of formula operator identifiers;
(d) cause the formula to be displayed according to the sequence, the formula displaying the selected component identifiers and the at least one operator identifier;
(e) repeat steps (a) through (d) for the user's building of another formula; and
(f) display a list of the formula identifiers.

18. The method of claim 16, which includes electronically storing the mathematical components, the stored mathematical components selected from the group consisting of a variable, a constant, a value, a function, an argument, and a condition, wherein each one of the component identifiers includes at least one letter of a word which is at least partially descriptive of the mathematical component associated with the component identifier.

19. The method of claim 16, which includes electronically executing the computer readable instructions to: (a) receive a build formula input from the user; (b) cause a component data field to be displayed in response to the build formula input; (c) receive at least one letter entered into the component data field by the user; (d) in response to the entered letter, cause at least part of a component identifier list to be displayed in alphabetical order, the displayed part including a plurality of the component identifiers which begin with the letter; and (e) receive a selection signal based on the user's pointing to one of the component identifiers in the component identifier list.

20. The method of claim 19, which includes electronically executing the computer readable instructions to: (a) cause an operator identifier list to be displayed after at least one of the component identifiers has been selected, the operator identifier list displaying a list of a plurality of the operator identifiers in alphabetical order; (b) receive another selection signal based on the user's pointing to one of the operator identifiers in the operator identifier list.
